(19) United States
(12) Patent Application Publication
(10) Pub. No.: US 2026/0066204 A1
(43) Pub. Date: Mar. 5, 2026

(54) CONTACTOR ARRANGEMENT AND METHOD FOR OPERATING A CONTACTOR ARRANGEMENT

(71) Applicant: EATON INTELLIGENT POWER LIMITED, Dublin 4 (IE)

(72) Inventors: Alexej POGORELOV, Erkelenz (DE); Volker LANG, Bonn (DE); Norbert ROESNER, Bonn (DE)

(21) Appl. No.: 19/108,262

(22) PCT Filed: Oct. 10, 2023
(86) PCT No.: PCT/EP2023/025429

§ 371 Date: Mar. 3, 2025

(30) Foreign Application Priority Data
Oct. 11, 2022 (GB) 2214959.5

(51) Int. Cl. H01H 47/00; G01K 1/02; G01K 3/00; G01K 7/22; G01K 15/00; H01H 50/12

(52) U.S. Cl. CPC H01H 47/002; G01K 1/026; G01K 3/005; G01K 7/22; G01K 15/005; H01H 50/12

(57) ABSTRACT

A contactor arrangement is specified herein, comprising:
a contactor with a contact bridge for switching an electrical connection between a first terminal and a second terminal during operation,
a first temperature sensor in direct contact with the first terminal or with a bus bar that is electrically connected to the first terminal,
a second temperature sensor configured for measuring an ambient temperature outside of the contactor during operation, and
a control unit configured for computing an internal temperature of the contact bridge inside the contactor, wherein
the internal temperature depends on temperature readings of the first temperature sensor and the second temperature sensor, and
the control unit is configured to provide a warning signal if the internal temperature exceeds a threshold value.

Further, a method for operating a contactor arrangement is specified herein.

### CROSS-REFERENCE TO RELATED APPLICATIONS

This application is a national phase filing under 35 C.F.R. § 371 of and claims priority to PCT Patent Application No. PCT/EP2023/025429, filed on Oct. 10, 2023, which claims the priority benefit under 35 U.S.C. § 119 of British Patent Application No. 2214959.5, filed on Oct. 11, 2022, the contents of which are hereby incorporated in their entireties by reference.

### DESCRIPTION

A contactor arrangement and a method for operating a contactor arrangement are specified herein.

Contactors are used in electric powered vehicles or other electric devices for carrying high electrical currents, such as electrical currents in excess of 100 Ampere, for example. For example, the contactor comprises fixed as well as movable contact elements arranged within a housing. The contact elements are electrically connected to terminals of the contactor. In particular, the movable contact element may open or close an electrical connection between two terminals by opening or closing a contact with one or more fixed contact elements. For example, the movable contact element, such as a contact bridge, may open or close a single contact with one fixed contact element, or it may simultaneously open or close two contacts with two fixed contact elements connected to the respective terminals. The movable contact element can be moved by applying a force, such as a mechanical force or an electromagnetic force. For example, the contactor comprises a driver coil that switches the movable contact element by a magnetic force, if an electric current flows through the driver coil.

The movable contact elements inside the contactor may carry large electrical currents and thus may exhibit a large thermal stress. For example, heat is generated due to an electrical contact resistance between the movable and fixed contact elements. Excess heat may be trapped inside the contactor housing and may damage components of the contactor during operation. In order to avoid damaging the contactor during operation, it would be advantageous to derate the contactor if a temperature inside the contactor exceeds a maximum operating temperature. For example, the electrical current flowing through the contact bridge is reduced upon derating the contactor, such that the amount of heat generated inside the contactor is reduced. However, arranging a temperature sensor inside the contactor in direct vicinity of the contact bridge might not be feasible due to structural restrictions and/or due to electromagnetic interference, for example. Moreover, arranging a temperature sensor inside the contactor might increase a production cost of the contactor.

At least one object of certain embodiments is to provide a contactor arrangement that can be operated without overheating, as well a method for operating said contactor arrangement.

This objective is achieved by the subject matter of the independent claims. Further embodiments and further advantageous developments are specified in the dependent claims.

According to an embodiment, the contactor arrangement comprises a contactor with a contact bridge for switching an electrical connection between a first terminal and a second terminal during operation. For example, the contact bridge is movable during operation and allows to open or close the electrical connection between the first terminal and the second terminal. The first terminal and the second terminal are configured for an external electrical contacting of the contactor. For example, a bus bar for transporting high electric currents to and from the contactor is connected to the first terminal and/or to the second terminal.

According to a further embodiment, the contactor arrangement comprises a first temperature sensor in direct contact with the first terminal or with a bus bar that is electrically connected to the first terminal. For example, the first temperature sensor is arranged outside of a housing of the contactor. Preferably, the first temperature sensor is configured to measure a temperature of the first terminal or of the bus bar connected to the first terminal during operation. Here and in the following, the temperature of the first terminal or of the bus bar connected to the first terminal measured by the first temperature sensor is denoted as “external temperature”.

For example, the first temperature sensor is a temperature dependent electrical resistor or a thermistor. The thermistor may have a positive temperature coefficient (PTC) or a negative temperature coefficient (NTC). Advantageously, the first temperature sensor may be arranged as close to the contact bridge as possible.

According to a further embodiment, the contactor arrangement comprises a second temperature sensor configured for measuring an ambient temperature outside of the contactor during operation. For example, the second temperature sensor is arranged on the housing of the contactor or on a carrier, where the contactor is mounted. In particular, the second temperature sensor is not in direct contact with the first terminal, the second terminal, or the bus bar connected to the first or second terminals. For example, the second temperature sensor is a temperature dependent electrical resistor or a thermistor.

According to a further embodiment, the contactor arrangement comprises a control unit configured for computing an internal temperature of the contact bridge inside the contactor. In other words, the control unit predicts the internal temperature of the contact bridge. For example, the control unit comprises or consists of an integrated circuit or an application specific integrated circuit (ASIC). In particular, the control unit takes readings of external sensors, such as the first and second temperature sensors, as input data. Preferably, the control unit processes the input data to generate an output. For example, the control unit comprises an analog-digital converter and a processing unit to perform mathematical operations with said input data.

In particular, the control unit is configured for computing the internal temperature of the contact bridge as a function of time during operation. In other words, the internal temperature is computed at a series of subsequent time steps based on time dependent input data during operation.

Preferably, the control unit is configured to compute the internal temperature with a high accuracy. In other words, a difference between the predicted internal temperature and the actual temperature of the contact bridge inside the contactor at any time during operation is small. For example, the predicted internal temperature differs from the actual temperature of the contact bridge by at most 20° C., or by at most 10° C., or by at most 5° C. Advantageously, by computing the internal temperature with a higher accuracy, a smaller temperature safety margin may be required for safely operating the contactor arrangement, thereby improving the performance of the contactor arrangement. In particular, during safe operation the internal contactor temperature does not exceed a maximum allowed operating temperature, thereby avoiding damage to the contactor arrangement.

According to a further embodiment of the contactor arrangement, the internal temperature depends on temperature readings of the first temperature sensor and the second temperature sensor. In other words, the control unit takes the external temperature readings and the ambient temperature readings as input data in order to compute the internal temperature of the contact bridge inside the contactor. In order to increase the accuracy of the computed internal temperature, the first temperature sensor may be arranged as close as possible to the contact bridge.

According to a further embodiment of the contactor arrangement, the control unit is configured to provide a warning signal if the internal temperature exceeds a threshold value. For example, the warning signal is an output generated by the control unit based on computations performed on the input data. For example, a derating of the contactor is performed after the warning signal is generated. The derating may involve a reduction of the electrical current flowing through the contact bridge, for example, in order to protect the contactor from thermal damage.

For example, the threshold value is a temperature value corresponding to a thermal load limit of the contactor. In other words, the threshold value corresponds to a maximum operating temperature of the contactor. For example, the maximum operating temperature may correspond to 230° C. during continuous operation, or to 250° C. for a maximal operation time of 5 minutes. In particular, the contactor may be damaged if the internal temperature exceeds the maximum operating temperature. The threshold value may include a safety margin and can be lower than the maximum operating temperature of the contactor. For example, the threshold value may be lower than the maximum operating temperature by 10° C., preferably by 5° C.

For a contactor comprising more than one contact bridge, the control unit may be configured to compute the internal temperature of each contact bridge separately. In this case, a warning signal may be provided by the control unit depending on the largest of the predicted temperatures, for example.

According to a preferred embodiment, the contactor arrangement comprises:
a contactor with a contact bridge for switching an electrical connection between a first terminal and a second terminal during operation,
a first temperature sensor in direct contact with the first terminal or with a bus bar that is electrically connected to the first terminal,
a second temperature sensor configured for measuring an ambient temperature outside of the contactor during operation, and
a control unit configured for computing an internal temperature of the contact bridge inside the contactor, wherein
the internal temperature depends on temperature readings of the first temperature sensor and the second temperature sensor, and
the control unit is configured to provide a warning signal if the internal temperature exceeds a threshold value.

The contactor arrangement disclosed herein is based on the idea that computing and thereby predicting the internal temperature of the contact bridge inside the contactor with a high accuracy allows to operate the contactor close to or at its thermal load limit. In other words, by computing the internal temperature, the contactor can be operated safely close to its maximum operating temperature without requiring large safety margins based on worst case assumptions. In particular, without an accurate internal temperature estimation, restrictive worst case assumptions would lead to a significant loss in performance of the contactor at regular operating conditions. For example, without an accurate internal temperature estimation an unnecessary derating of the contactor might be triggered at relatively low internal temperatures compared to the maximum operating temperature. By contrast, the contactor arrangement specified herein can be operated safely at all times and at all operating conditions without compromising its performance or with a minimal loss in performance. Here, performance refers to operating the contactor as close to its design limit as possible, and in particular as close to its maximum allowed operating temperature as possible.

For example, the actual temperature of the contact bridge inside the contactor depends on a pole resistance of the contact bridge that may vary during operation or over a lifetime of the contactor and that may be hard to measure. Moreover, the actual temperature of the contact bridge may be difficult to measure directly due to structural restrictions inside to contactor and/or due to electromagnetic interference from the switching of high electric currents during operation, for example. In addition, the difference between the external temperature and the internal temperature may be highly time dependent and may increase with increasing electric current flowing through the contact bridge and/or due to a change of the pole resistance. Accordingly, estimating the internal temperature solely from a measurement of the external temperature might not be sufficient for an accurate determination of the internal temperature. By contrast, the contactor arrangement disclosed herein allows to determine the internal temperature with high accuracy, based on measurements of both, the external temperature and the ambient temperature. Advantageously, a temperature measurement directly at the contact bridge is not necessary for an accurate determination of the internal temperature.

According to a further embodiment of the contactor arrangement, the contact bridge is configured to carry a maximal electrical current of at least 350 Amperes. For example, the contact bridge is configured to carry a maximal electrical current of at least 500 Amperes, or of at least 1000 Amperes. In particular, the contact bridge is configured to carry the maximal electrical current continuously without a time limitation. Due to the carrying of such high electrical currents, the contact bridge may be thermally stressed. Accordingly, determining the internal temperature of the contact bridge is advantageous to protect the contactor from thermal damage during operation.

According to a further embodiment of the contactor arrangement, the contactor comprises active or passive cooling. For example, the housing of the contactor comprises a passive cooling element or a heat sink. Alternatively or in addition, the heat sink may be arranged in thermal contact with the bus bars in close vicinity to the terminals, in order to dissipate heat generated inside the contactor efficiently. The contactor arrangement may also comprise an active cooling system, such as a liquid cooling system, an electrically driven fan, a heat pump, or an evaporative cooler, for example, in order to actively cool the contactor during operation. For example, the liquid cooling system comprises a cooling plate thermally connected to a bus bar, wherein a liquid coolant such as water flows through channels inside the cooling plate. In particular, active or passive cooling may increase an electrical load limit of the contactor.

According to a further embodiment, the contactor arrangement further comprises an air pressure sensor for measuring an ambient air pressure outside the contactor, and the control unit is configured to compute the internal temperature further depending on a reading of the air pressure sensor. In other words, the ambient air pressure is part of the input data for the control unit. For example, the control unit computes the internal temperature based on the ambient air pressure reading besides other input data, such as temperature readings from the first temperature sensor and the second temperature sensor.

According to a further embodiment, the contactor arrangement further comprises an electrical current sensor for measuring the electrical current flowing through the contact bridge during operation, and the control unit is configured to compute the internal temperature further depending on a reading of the electrical current sensor. In other words, the electrical current flowing through the contact bridge during operation is part of the input data for the control unit. For example, the control unit computes the internal temperature based on the electrical current reading besides other input data, such as temperature readings from the first temperature sensor and the second temperature sensor, as well as readings from the ambient air pressure sensor.

According to a further embodiment of the contactor arrangement the internal temperature depends on readings of the first temperature sensor at two subsequent time steps. For example, the computed internal temperature depends on the current external temperature reading and on a past external temperature reading. For example, the control unit comprises a memory for storing the external temperature reading at a time step before the time at which the internal temperature is computed.

According to a further embodiment of the contactor arrangement, a time interval between the two subsequent time steps is smaller than or equal to a characteristic heating time of the first terminal and/or of the bus bar. Here and in the following, the characteristic heating time of the first terminal is a property of the contactor arrangement that specifies a time span after which the temperature of the first terminal reaches 63% of an equilibrium temperature, while a constant electric current flowing through the first terminal gives rise to Ohmic heating. Similarly, the characteristic heating time of the bus bar is a property of the contactor arrangement that specifies a time span after which the temperature of the bus bar reaches 63% of an equilibrium temperature, while a constant electric current flowing through the bus bar gives rise to Ohmic heating. Advantageously, the accuracy of the computed internal temperature can be increased by using a time interval between subsequent time steps that is smaller than the characteristic heating time of the first terminal and/or of the bus bar.

Further, a method for operating a contactor arrangement is specified herein. In particular, the method is configured to operate the contactor arrangement as specified herein. All features of the contactor arrangement are also disclosed for the method for operating a contactor arrangement, and vice versa.

According to an embodiment, the method for operating a contactor arrangement comprises a step of measuring an external temperature of a contactor at a first terminal of the contactor or at a bus bar that is electrically connected to the first terminal of the contactor.

According to a further embodiment, the method for operating a contactor arrangement comprises a step of measuring an ambient temperature outside of the contactor. For example, the ambient temperature is measured at a distance from parts of the contactor arrangement carrying the electrical current, such as the bus bar or the terminals of the contactor.

According to a further embodiment, the method for operating a contactor arrangement comprises a step of computing an internal temperature of a contact bridge inside the contactor, wherein the internal temperature depends on the external temperature and on the ambient temperature, and the contact bridge is configured for switching an electrical connection between the first terminal and a second terminal of the contactor. For example, the internal temperature is computed by a control unit that takes readings of the external temperature and of the ambient temperature as input data.

According to a further embodiment, the method for operating a contactor arrangement comprises a step of providing a warning signal, if the internal temperature exceeds a threshold value. For example, the threshold value corresponds to a maximum operating temperature of the contact bridge. For example, the warning signal is generated as an output of the control unit and may be further used for a derating of the contactor in order to avoid damage from overheating.

Moreover, the control unit may provide a rate of increase of the internal temperature as a function of time as a further output. In other words, the control unit may provide information on how fast the internal temperature exceeds the threshold value. For example, the derating of the contactor may be adjusted according to the rate of increase of the internal temperature. For example, a derating where the current flowing through the contact bridge is decreased is proportional to the rate of increase of the internal temperature. The control unit may be used to derate and/or to control the contactor, such that the contactor operates at or close to its thermal load limit, thereby avoiding a loss of performance.

According to a further embodiment of the method for operating a contactor arrangement, the internal temperature is computed via the relation

$${T}_{2}^{i} = {T}_{1}^{i} + ( {T}_{ma x}^{i} - {T}_{1}^{i} ) \cdot ( 1 - {e}^{\frac{{t}_{2} - {t}_{1}}{{τ}_{i}}} ) , where {T}_{2}^{i}$$

denotes the internal temperature at a time t₂,

$${T}_{1}^{i}$$

denotes the internal temperature at an earlier time t₁, τᵢ is a characteristic heating time of the contact bridge, and

$${T}_{ma x}^{i}$$

is determined from the measured external temperature and from the measured ambient temperature. Here and in the following, the characteristic heating time of the contact bridge is a property of the contactor arrangement that specifies a time span after which the temperature of the contact bridge reaches 63% of an equilibrium temperature, while a constant electric current flowing through the contact bridge gives rise to Ohmic heating.

The characteristic heating time τᵢ is a property of the contactor arrangement and may be used as a parameter for computing the internal temperature. For example, the characteristic heating time can be determined during an initial calibration step and may be stored in the control unit. Alternatively or in addition, the characteristic heating time may be determined statistically from measurements on a large number of similar contactor arrangements.

In particular, the computed internal temperature

$${T}_{2}^{i}$$

depends on a value of the internal temperature

$${T}_{1}^{i}$$

computed in a previous time step. As an initial condition for computing the internal temperature, the initial internal temperature may be set to the measured ambient temperature, if the contactor has had sufficient time to cool down to the ambient temperature.

Alternatively, the initial condition for the computed internal temperature may be determined from the relation

$${T}_{initial}^{i} = {T}_{on}^{amb} + ( {T}_{off}^{i} - {T}_{on}^{amb} ) \times {e}^{\frac{Δ t}{{τ}_{i}}} ,$$

which takes a partial cooling of the contact bridge after a previous operation of the contactor into account. Here

$${T}_{initial}^{i}$$

denotes the initial condition for the internal temperature,

$${T}_{on}^{amb}$$

is the ambient temperature at the initial time,

$${T}_{off}^{i}$$

is the computed internal temperature at a time when the contactor arrangement was previously switched off, and Δt is the cooling time span between the time when the contactor was switched off and the initial time.

According to a further embodiment of the method for operating a contractor arrangement

$${T}_{max}^{i}$$

is computed via the relation

$${T}_{max}^{i} = P [ ( {T}_{2}^{e} - {T}_{1}^{e} ) / ( 1 - {e}^{- \frac{{t}_{2} - {t}_{1}}{{τ}_{e}}} ) + {T}_{1}^{e} - {T}_{2}^{amb} ] + {T}_{2}^{amb} ,$$

$$where {T}_{1}^{e} and {T}_{2}^{e}$$

are the measured external temperatures at times t₁ and t₂, respectively,

$${T}_{2}^{amb}$$

is the measured ambient temperature at time t₂, P is a calibration parameter and τₑ is the characteristic heating time of first terminal and/or of the bus bar. For example, the heating time of the bus bar or of the first terminal is larger than the heating time of the contact bridge τₑ>τᵢ. The calibration parameter P and the characteristic heating time τₑ are parameters for computing the internal temperature and may be stored in the control unit.

In particular, the calibration parameter P follows from the assumption that the external temperature and the internal temperature are proportional to each other in thermal equilibrium. In other words, it is assumed that the relation

$${T}_{max}^{i} - {T}_{2}^{amb} = P ( {T}_{max}^{e} - {T}_{2}^{amb} ) holds , where {T}_{max}^{i} and {T}_{max}^{e}$$

are steady state values of the internal temperature and of the external temperature in thermal equilibrium, respectively, whereas

$${T}_{2}^{amb}$$

denotes the ambient temperature. For example, a steady state value of the internal temperature is larger than a steady state value of the external temperature and therefore P>1.

According to a further embodiment of the method for operating a contactor arrangement, wherein the characteristic heating time τᵢ of the contact bridge and/or the characteristic heating time τₑ of the first terminal or the bus bar depends on an ambient air pressure. For example, the accuracy of the computed internal temperature can be increased, if τᵢ and/or τₑ are adjusted according to the ambient air pressure measured by an ambient air pressure sensor, for example.

According to a further embodiment of the method for operating a contactor arrangement, the calibration parameter P depends on an electrical current flowing through the contact bridge during operation. In particular, the accuracy of the computed internal temperature can be increased, if P is adjusted according to the electrical current flowing through the contact bridge measured by an electrical current sensor.

Further advantageous embodiments and further embodiments of the contactor arrangement and the method for operating a contactor arrangement become apparent from the following exemplary embodiments described in connection with the figures.

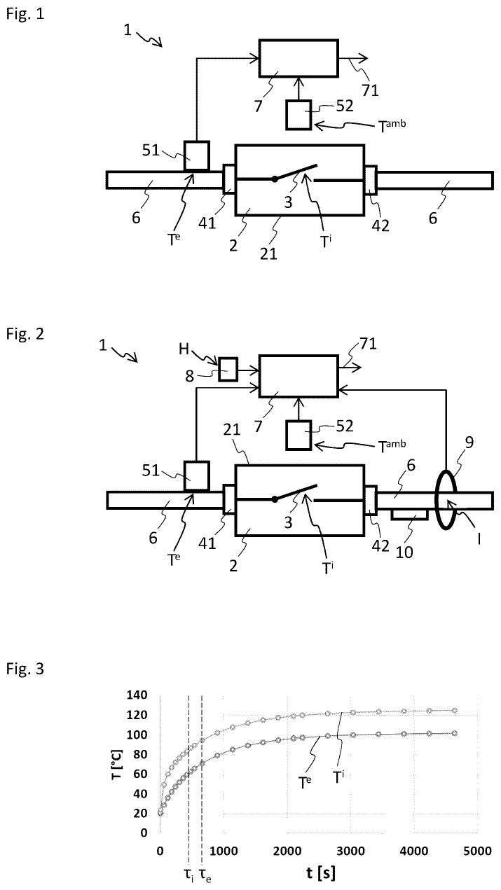

FIGS. 1 and 2 show schematic contactor arrangements according to different exemplary embodiments.

FIG. 3 shows temperature evolution of a contactor arrangement according to an exemplary embodiment.

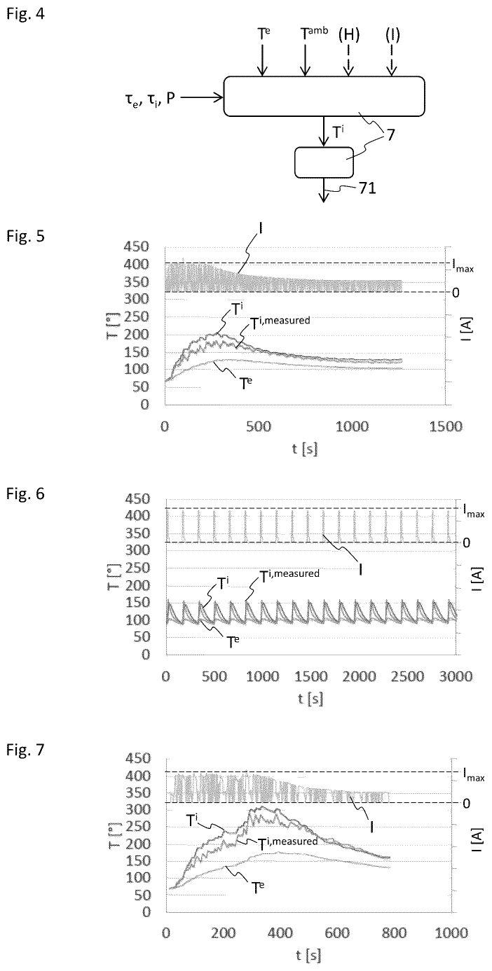

FIG. 4 shows a diagram corresponding to a method for operating a contactor arrangement according to an exemplary embodiment.

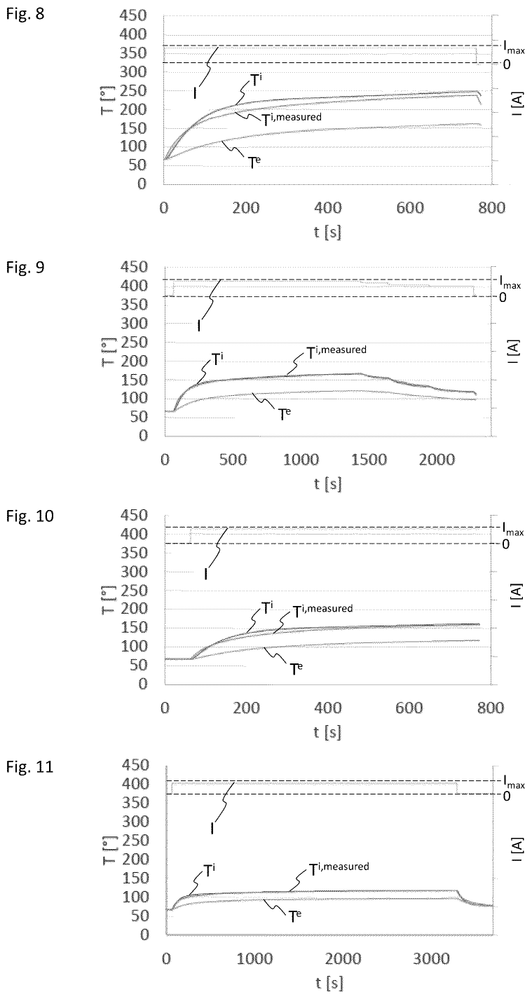

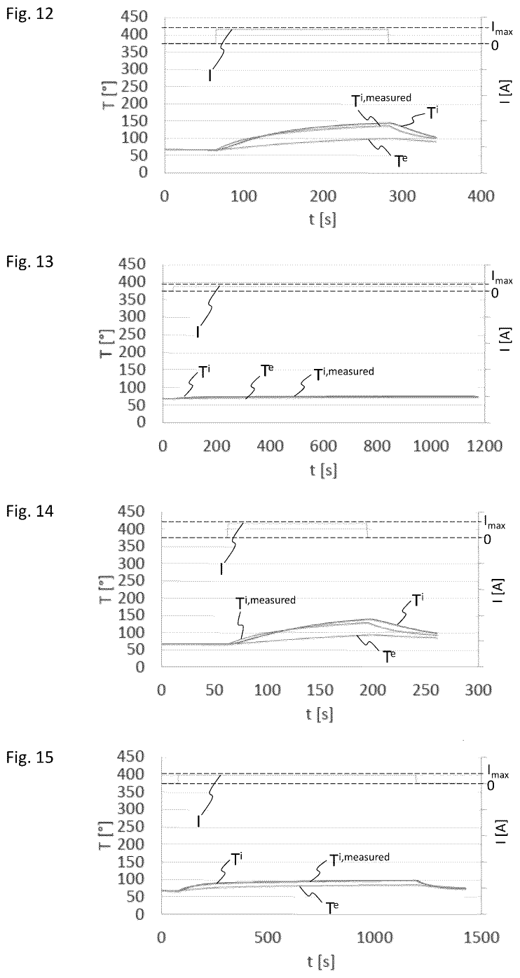

FIGS. 5 to 15 show different temperature evolutions of a contactor arrangement according to an exemplary embodiment.

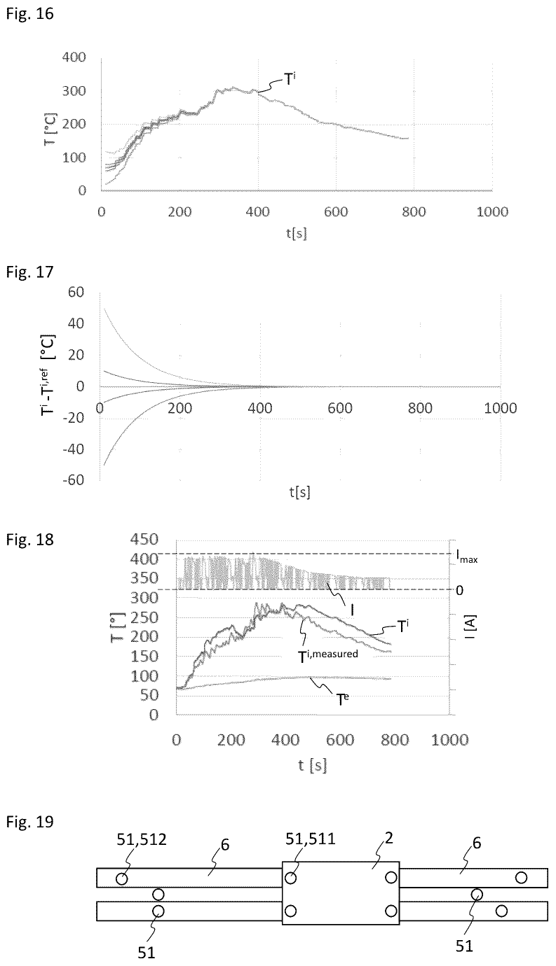

FIGS. 16 and 17 show an impact of different initial conditions on the time evolution of the computed internal temperature Tⁱ of a contactor arrangement according to an exemplary embodiment.

FIG. 18 shows the impact of different arrangements of the first temperature sensor on the time evolution of the computed internal temperature Tⁱ of a contactor arrangement according to an exemplary embodiment.

FIG. 19 shows a schematic top view of part of a contactor arrangement according to an exemplary embodiment with different mounting positions of the first temperature sensor.

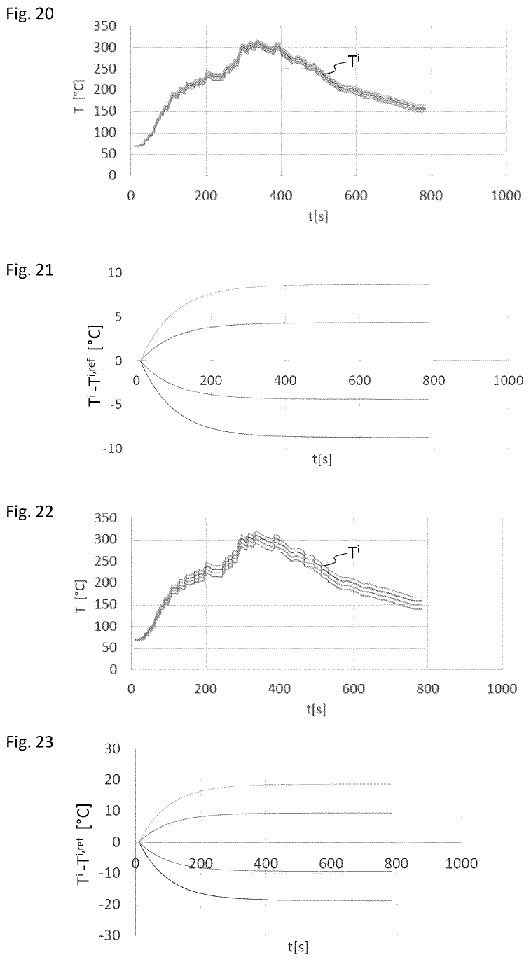

FIGS. 20 and 21 show an impact of an error of the second temperature sensor on the time evolution of the computed internal temperature Tⁱ of a contactor arrangement according to an exemplary embodiment.

FIGS. 22 and 23 show an impact of an error of the first temperature sensor on the time evolution of the computed internal temperature Tⁱ of a contactor arrangement according to an exemplary embodiment.

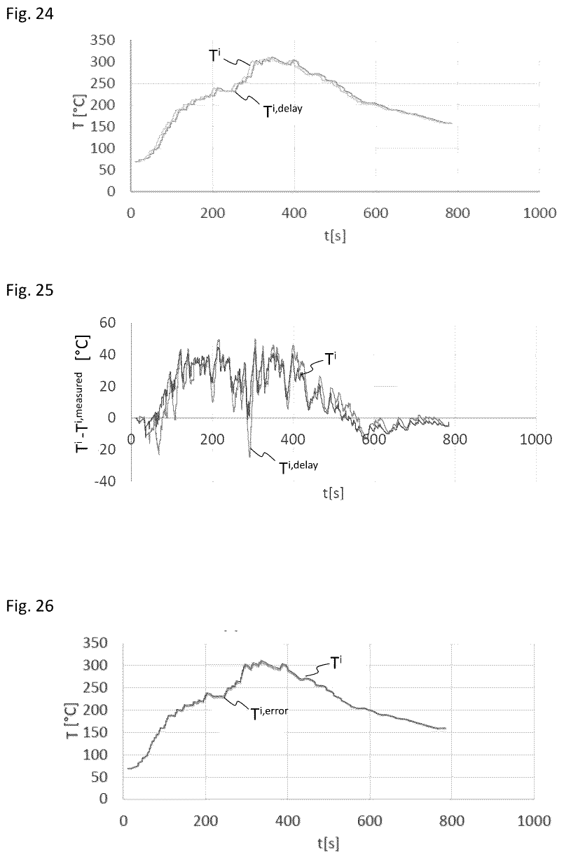

FIGS. 24 and 25 show an impact of a time delay between readings of the first and second temperature sensors and the computation of the internal temperature Tⁱ of a contactor arrangement according to an exemplary embodiment.

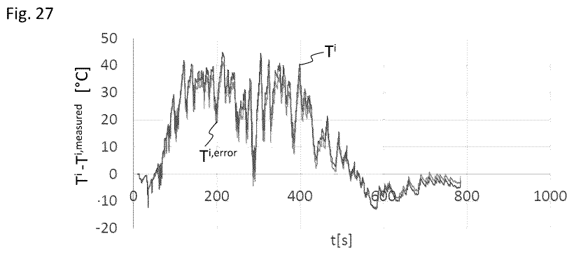

FIGS. 26 and 27 show an impact of an error of the characteristic heating times on the time evolution of the computed internal temperature Tⁱ of a contactor arrangement according to an exemplary embodiment.

Elements that are identical, similar, or have the same effect, are denoted by the same reference signs in the Figures. The Figures and the proportions of the elements shown in the Figures are not to be regarded as true to scale. Rather, individual elements may be shown exaggeratedly large for better representability and/or better understanding.

The contactor arrangement 1 according to the exemplary embodiment in FIG. 1 comprises a contactor 2, a first temperature sensor 51, a second temperature sensor 52 and a control unit 7. The contactor 2 comprises a housing 21 and a movable contact bridge 3 inside the housing 21. The contact bridge 3 is configured for switching an electrical connection between a first terminal 41 and a second terminal 42. Bus bars 6 for transporting high electrical currents to and from the contactor 2 are electrically connected to the first and second terminals 41, 42. For example, the bus bars 6 are further connected to a battery and to an electrical motor (not shown) and the contactor 2 is configured to switch the electrical connection between the battery and the motor during operation.

The first temperature sensor 51 is in direct contact with the bus bar 6 connected to the first terminal 41 and configured for measuring an external temperature T^{e}. The second temperature sensor 52 is configured for measuring an ambient temperature T^{amb} outside the contactor housing 21.

The control unit 7 is configured for computing an internal temperature Tⁱ of the contact bridge 3 based on readings of the first and second temperature sensors 51, 52. In particular, the control unit 7 computes the internal temperature Tⁱ with high accuracy and dynamically as a function of time at a series of discrete time steps during operation. Moreover, the control unit 7 is configured to generate a warning signal 71 if the computed internal temperature Tⁱ exceeds a threshold value in order to protect the contactor 2 from thermal damage during operation. For example, the threshold value is equal to the maximum operating temperature of the contactor 2.

Compared to the contactor arrangement 1 disclosed with regard to FIG. 1, the contactor arrangement 1 according to the exemplary embodiment in FIG. 2 further comprises an ambient air pressure sensor 8, an electrical current sensor 9 and an element for cooling 10 the contactor. The ambient air pressure sensor 8 is configured to measure an ambient air pressure H outside the contactor housing 21 during operation, while the electrical current sensor 9 is configured to measure an electrical current I flowing through the contact bridge 3 during operation. The element for cooling 10 is a heat sink thermally coupled to the bus bar 6 of the contactor arrangement 1. Elements for cooling 10 may also be arranged at each bus bar 6 for an efficient dissipation of heat generated inside the contactor 2. Each of the elements ambient air pressure sensor 8, electrical current sensor 9 and element for cooling 10 may be individually included in the embodiment of FIG. 1 as optional elements.

The control unit 7 takes readings of the first and second temperature sensors 51, 52, the ambient air pressure sensor 8 and the electrical current sensor 9 to compute the internal temperature Tⁱ. Compared to the exemplary embodiment in FIG. 1, the additional readings of the ambient air pressure sensor 8 and the electrical current sensor 9 allow to compute the internal temperature Tⁱ with higher accuracy.

FIG. 3 shows the internal temperature Tⁱ and the measured external temperature T^{e} of the contactor arrangement 1 described with regard to FIG. 1 as a function of time t. In particular, FIG. 3 shows the time evolution of the internal and external temperatures Tⁱ and T^{e} while a constant electrical current of 350 A at an ambient temperature T^{amb} of 20° C. is flowing through the contact bridge 3. The internal temperature Tⁱ increases faster than the external temperature T^{e}. Accordingly, the characteristic heating time τᵢ of the contact bridge 3 is smaller than the characteristic heating time τₑ of the bus bar 6. Moreover, the internal temperature Tⁱ is higher than the external temperature T^{e}.

The diagram in FIG. 4 depicts the method for operating the contactor arrangement according to an exemplary embodiment. In particular, the control unit 7 takes readings of the external temperature T^{e} measured by the first temperature sensor 51 and of the ambient temperature T^{amb} measured by the second temperature sensor 52 as input data. Furthermore, the control unit 7 takes stored values of the characteristic heating time of the contact bridge τᵢ, the characteristic heating time of the first terminal or the bus bar τₑ, as well as a calibration parameter P together with the input data to compute the internal temperature Tⁱ of the contact bridge 3.

If the computed internal temperature Tⁱ exceeds a threshold value, the control unit 7 provides a warning signal 71 as output data. In order to improve the accuracy of the predicted internal temperature Tⁱ, the control unit 7 may use optional ambient air pressure H readings from an ambient air pressure sensor 8, as well as optional electrical current I readings from an electrical current sensor 9 as further input data.

FIGS. 5 to 15 show the time evolution of the computed internal temperature Tⁱ, the actual internal temperature T^{i,measured} of the contact bridge 3, and the measured external temperature T^{e} in response to different time dependent electrical currents I flowing through the contact bridge 3 of a contactor arrangement 1 according to the exemplary embodiment described in connection with FIG. 1. A maximal electrical current Iₘₐₓ of the respective time dependent electrical current profiles takes values between 100 A and 1500 A for the different examples. In particular, FIGS. 5 to 16 show that the computed internal temperature Tⁱ accurately predicts the actual internal temperature T^{i,measured} of the contact bridge 3 irrespective of the detailed form of the electrical current I profile.

FIG. 16 shows the time evolution of the computed internal temperature Tⁱ for the contactor arrangement 1 described in connection with FIG. 1 operated with the electrical current I profile shown in FIG. 7. The different internal temperature Tⁱ curves are computed for initial conditions of the internal temperature that deviate by ±10° C. and by ±50° C. After a time of around 300 seconds the computed internal temperature is approximately independent of the initial condition.

FIG. 17 shows the same data as FIG. 16, but the computed internal temperature T^{i,ref} for a given reference initial condition is subtracted from the computed internal temperatures Tⁱ corresponding to different initial conditions.

FIG. 18 shows analogous data as FIG. 7, but the computed internal temperature Tⁱ corresponds to a contactor arrangement 1 where the first temperature sensor 51 is arranged at a larger distance from the first terminal 41. In particular, FIG. 18 shows that the difference between the computed internal temperature Tⁱ and the actual internal temperature T^{i,measured} of the contact bridge 3 is larger, and thus the accuracy of the computed internal temperature Tⁱ is lower, if the first temperature sensor 51 is arranged at a larger distance from the contact bridge 3 compared to FIG. 7.

FIG. 19 shows different mounting positions 511, 512 for the first temperature sensor 51 within the contactor arrangement 1 described in connection with FIG. 1. The first mounting position 511 is at the first terminal 41, whereas the second mounting position is on the bus bar 6 at a distance from the first terminal 41. In particular, the computed internal temperature Tⁱ shown in FIG. 7 corresponds to a first temperature sensor 51 mounted at the first mounting position 511, whereas the computed internal temperature Tⁱ shown in FIG. 18 corresponds to a first temperature sensor 51 mounted at the second mounting position 512.

FIG. 20 shows the time evolution of the computed internal temperature Tⁱ for the contactor arrangement 1 described in connection with FIG. 1 operated with the electrical current I profile shown in FIG. 7. The different internal temperature Tⁱ curves are computed for different exemplary errors of +5° C. and +10° C. of ambient temperature T^{amb} readings of the second temperature sensor 52.

FIG. 21 shows the same data as FIG. 20, but the computed internal temperature T^{i,ref} without an error of the ambient temperature T^{amb} reading is subtracted from the computed internal temperatures Tⁱ corresponding to different erroneous ambient temperature T^{amb} readings. In particular, the error of the computed internal temperature Tⁱ is smaller than the error of the ambient temperature T^{amb} reading.

FIG. 22 shows the time evolution of the computed internal temperature Tⁱ for the contactor arrangement 1 described in connection with FIG. 1 operated with the electrical current I profile shown in FIG. 7. The different internal temperature Tⁱ curves are computed for different errors of +5° C. and +10° C. of external temperature T^{e} readings of the first temperature sensor 51.

FIG. 23 shows the same data as FIG. 22, but the computed internal temperature T^{i,ref} without an error of the external temperature T^{e} reading is subtracted from the computed internal temperatures Tⁱ corresponding to different erroneous external temperature T^{e} readings. In particular, the error of the computed internal temperature Tⁱ is larger than the error of the external temperature T^{e} reading.

FIG. 24 shows the time evolution of the computed internal temperature Tⁱ for the contactor arrangement 1 described in connection with FIG. 1 operated with the electrical current I profile shown in FIG. 7. In particular, T^{i,delay} corresponds to a computed internal temperature where the readings of the first and second temperature sensors 51, 52 are delayed by 10 s at the time when the internal temperature Tⁱ is computed.

FIG. 25 shows the same data as FIG. 24, but the actual internal temperature T^{i,measured} of the contact bridge 3 is subtracted from the computed internal temperatures Tⁱ and T^{i,delay}. A time delay in temperature measurement of 10 s shifts the predicted internal temperature Tⁱ by 10 s, leading to a slightly increased underprediction when the temperature increases and a lightly increased overprediction when temperature decreases. However, the calibration parameters can be adjusted to optimize the prediction if the time delay is known.

FIG. 26 shows the time evolution of the computed internal temperature Tⁱ for the contactor arrangement 1 described in connection with FIG. 1 operated with the electrical current I profile shown in FIG. 7. The different internal temperature curves T^{i,error} and Tⁱ are computed with and without an error of −10% in the characteristic heating times Tⁱ and the of the contact bridge 3 and the bus bar 6.

FIG. 27 shows the same data as FIG. 26, but the actual internal temperature T^{i,measured} of the contact bridge 3 is subtracted from the computed internal temperatures Tⁱ and T^{i,error}. A decrease of the characteristic heating times τᵢ and τ^{e} by 10% has a negligible effect on the accuracy of the computed internal temperature Tⁱ.

The presently disclosed subject matter is not restricted to the exemplary embodiments by the description on the basis of said exemplary embodiments. Rather, the presently disclosed subject matter encompasses any new feature and also any combination of features, which in particular comprises any combination of features in the patent claims and any combination of features in the exemplary embodiments, even if this feature or this combination itself is not explicitly specified in the patent claims or exemplary embodiments.

### REFERENCE NUMERALS

1 contactor arrangement
2 contactor
21 housing
3 contact bridge
41 first terminal
42 second terminal
51 first temperature sensor
511 first mounting position
512 second mounting position
52 second temperature sensor
6 bus bar
7 control unit
71 warning signal
8 air pressure sensor
9 electrical current sensor
10 cooling
I electrical current
Iₘₐₓ maximal electrical current
H ambient air pressure
Tⁱ computed internal temperature
T^{i,measured} actual internal temperature
T^{i,delay} computed internal temperature with time delay
T^{i,error} computed internal temperature with error
T^{e} external temperature
T^{amb} ambient temperature
t time
⊖ᵢ heating time of the contact bridge
τₑ heating time of the bus bar/contact terminal
P calibration parameter

1. A contactor arrangement comprising:
a contactor with a contact bridge for switching an electrical connection between a first terminal and a second terminal during operation,
a first temperature sensor in direct contact with the first terminal or with a bus bar that is electrically connected to the first terminal,
a second temperature sensor configured for measuring an ambient temperature outside of the contactor during operation, and
a control unit configured for computing an internal temperature of the contact bridge inside the contactor, wherein
the internal temperature depends on temperature readings of the first temperature sensor and the second temperature sensor, and
the control unit is configured to provide a warning signal if the internal temperature exceeds a threshold value.

2. The contactor arrangement according to the previous claim 1,
wherein the contact bridge is configured to carry a maximal electrical current of at least 350 Amperes.

3. The contactor arrangement according to claim 1,
wherein the contactor comprises active or passive cooling.

4. The contactor arrangement according to claim 1, wherein
the contactor arrangement further comprises an air pressure sensor for measuring an ambient air pressure outside the contactor, and
the control unit is configured to compute the internal temperature further depending on a reading of the air pressure sensor.

5. The contactor arrangement according to claim 1, wherein
the contactor arrangement further comprises an electrical current sensor for measuring the electrical current flowing through the contact bridge during operation, and
the control unit is configured to compute the internal temperature further depending on a reading of the electrical current sensor.

6. The contactor arrangement according to claim 1,
wherein the internal temperature depends on readings of the first temperature sensor at two subsequent time steps.

7. The contactor arrangement according to claim 6,
wherein a time interval between the two subsequent time steps is smaller than or equal to a characteristic heating time of the first terminal and/or of the bus bar.

8. A method for operating a contactor arrangement, comprising the following steps:
measuring an external temperature of a contactor at a first terminal of the contactor or at a bus bar that is electrically connected to the first terminal of the contactor,
measuring an ambient temperature outside of the contactor,
computing an internal temperature of a contact bridge inside the contactor, wherein the internal temperature depends on the external temperature and on the ambient temperature, and the contact bridge is configured for switching an electrical connection between the first terminal and a second terminal of the contactor,
providing a warning signal, if the internal temperature exceeds a threshold value.

9. The method according to claim 8, wherein the internal temperature is computed via the relation
$${T}_{2}^{i} = {T}_{1}^{i} + ( {T}_{max}^{i} - {T}_{1}^{i} ) \cdot ( 1 - {e}^{- \frac{{t}_{2} - {t}_{1}}{{τ}_{e}}} ) , where {T}_{2}^{i}$$
denotes the internal temperature at a time t₂,
$${T}_{1}^{i}$$
denotes the internal temperature at an earlier time t₁, τᵢ is a characteristic heating time of the contact bridge, and
$${T}_{max}^{i}$$
is determined from the measured external temperature and from the measured ambient temperature.

10. The method according to claim 9, wherein
$${T}_{max}^{i}$$
is computed via the relation
$${T}_{max}^{i} = P [ ( {T}_{2}^{e} - {T}_{1}^{e} ) / ( 1 - {e}^{- \frac{{t}_{2} - {t}_{1}}{{τ}_{e}}} ) + {T}_{1}^{e} - {T}_{2}^{amb} ] + {T}_{2}^{amb} ,$$
$$where {T}_{1}^{e} and {T}_{2}^{e}$$
are the measured external temperatures at times t₁ and t₂, respectively,
$${T}_{2}^{amb}$$
is the measured ambient temperature at time t₂, P is a calibration parameter and τₑ is a characteristic heating time of first terminal and/or of the bus bar.

11. The method according to claim 10, wherein the characteristic heating time τᵢ of the contact bridge and/or the characteristic heating time τₑ of the first terminal or of the bus bar depends on an ambient air pressure.

12. The method according to claim 10,
wherein the calibration parameter P depends on an electrical current flowing through the contact bridge during operation.
